(19) United States
(12) Patent Application Publication
(10) Pub. No.: US 2011/0171509 A1
(43) Pub. Date: Jul. 14, 2011

(54) NON-AQUEOUS ELECTROLYTE SECONDARY BATTERY AND METHOD FOR PRODUCING THE SAME

(76) Inventors: Yasushi Nakagiri, Kyoto (JP); Yasuyuki Shibano, Nara (JP); Saori Tateishi, Osaka (JP); Norihiro Yamamoto, Osaka (JP)

(21) Appl. No.: 13/063,372

(22) PCT Filed: Jul. 6, 2010
(86) PCT No.: PCT/JP2010/004395

§ 371 Date: Mar. 10, 2011

(30) Foreign Application Priority Data
Jul. 31, 2009 (JP) 2009-178596

(51) Int. Cl. H01M 4/00; H01M 10/04

(52) U.S. Cl. 429/94; 29/623.3

(57) ABSTRACT

Disclosed is a non-aqueous electrolyte secondary battery including: an electrode assembly including a positive electrode including a belt-like positive electrode current collector and a positive electrode active material layer adhering to a surface of the positive electrode current collector, a negative electrode including a belt-like negative electrode current collector and a negative electrode active material layer adhering to a surface of the negative electrode current collector, and a separator for insulating the positive electrode from the negative electrode, the positive electrode, the negative electrode, and the separator being spirally wound together; and a non-aqueous electrolyte. The separator includes a heat resistant porous film including a heat resistant resin, a first polyolefin porous film covering entirely a surface of the heat resistant porous film on the positive electrode side, and a second polyolefin porous film covering entirely a surface of the heat resistant porous film on the negative electrode side. The heat resistant resin has a melting point or a heat deflection temperature higher than those of polyolefins included in the first and second polyolefin porous films. The heat resistant porous film has a thickness of 1 to 16 μm, each of the first and second polyolefin porous films has a thickness of 2 to 17 μm, and the separator has a thickness of 5 to 35 μm.

### TECHNICAL FIELD

The present invention relates to a non-aqueous electrolyte secondary battery capable of reducing defects in production and being produced with high productivity. More specifically, the present invention relates to a non-aqueous electrolyte secondary battery capable of reducing defects due to damage and the like to a separator in association with removal of a winding core from an electrode assembly.

### BACKGROUND ART

Non-aqueous electrolyte secondary batteries represented by lithium ion secondary batteries have a high energy density. However, the safety thereof must be sufficiently ensured because the battery temperature abruptly rises in the event of misuse such as external short circuiting and overcharging. In order to ensure the safety, in some cases, a safety mechanism such as a PTC (Positive Temperature Coefficient) element and an SU circuit (Safety Unit circuit) has been utilized, and in other cases, softening or melting properties of a resin constituting a separator have been utilized.

In a polyolefin porous film generally used as the separator, in the event of an increase in the battery temperature up to a certain temperature, the polyolefin softens to close the micropores in the film. As a result, the ion conductivity is lost, and the battery reaction is stopped. Such function is known as a shutdown function. Despite this, if the battery temperature is increased even after the shutdown, a meltdown in which the polyolefin melts occurs, and as a result, the positive and negative electrodes are short circuited.

The shutdown and meltdown are both attributed to the softening or melting properties of a resin constituting the separator. For this reason, it is difficult to prevent the meltdown effectively, while improving the shutdown function. For example, if the thermal melting property of the separator is improved in view of the shutdown function, the meltdown temperature is lowered.

In order to solve this problem, one proposal suggests using, as the separator, a composite film being a combination of a polyolefin porous film and a heat resistant layer.

For example, Patent Literature 1 uses, as the separator, a composite film having a porous heat resistant layer including a polyimide, a polyamide-imide, an aramid, or the like and a shutdown layer including polyethylene. This separator has a three-layer structure composed of an intermediate layer of polyethylene, a polypropylene layer disposed on the positive electrode side, and a thermal resistant layer disposed on the negative electrode side. Patent Literature 1 proposes to improve the safety by such a configuration.

Patent Literature 2 proposes to use a separator having a three-layer structure composed of a polyethylene intermediate layer and heat resistant layers on both sides thereof, in order to suppress the shrinkage in the event of shutdown, and thereby to improve the safety.

Many of non-aqueous electrolyte secondary batteries use an electrode assembly formed by winding spirally a belt-like positive electrode, a belt-like negative electrode and a belt-like separator together. In such an electrode assembly, two separators are overlapped with each other at a portion from which the winding of the electrode assembly starts, and the positive and negative electrodes are not present at this winding start portion. The winding is started from the state in which two separators are clamped with a pair of winding cores. After the electrode assembly has been formed, the clamping of the separators at the winding start portion is loosened, to remove the winding cores. However, there is a risk that the separators are displaced as the winding cores are being removed, and as a result, leakage of current may occur in a product, resulting in a product defect.

In order to suppress such separator displacement, Patent Literature 3 proposes to provide a polyolefin separator at the winding start portion with a resin layer having good slidability.

### CITATION LIST

### Patent Literature

[PTL 1] Japanese Laid-Open Patent Publication No. 2006-164873
[PTL 2] Japanese Laid-Open Patent Publication No. 2007-324073
[PTL 3] Japanese Laid-Open Patent Publication No. 2008-108492

### SUMMARY OF INVENTION

### Technical Problem

In Patent Literatures 1 and 2, a porous heat resistant layer is positioned at the outermost surface of the separator. Porous heat resistant layers are high in hardness and friction coefficient, and poor in slidability. In forming a spirally-wound electrode assembly, such a porous heat resistant layer is in contact with the winding core, and therefore, it is difficult to remove the winding core smoothly after winding. If the winding core is not removed smoothly, the separator at the winding start portion is displaced or damaged.

In the separator disclosed in Patent Literature 1, a porous heat resistant layer is arranged in the outermost surface layer in one side thereof, and therefore, the layer structure is not well balanced. As such, a winding displacement may occur in winding. If a winding displacement occurs, the battery characteristics and the battery safety are affected. Further, the defective rate is increased in the current leakage inspection in the process of battery fabrication.

In Patent Literature 3, only a polyolefin separator is used, and therefore, the heat resistance is insufficient. Moreover, the slidability is imparted only at the winding start portion, and therefore, it is necessary to exactly align the separators with each other and exactly align the separators with the positive and/or negative electrode. As a result, the productivity and the yield are reduced, and the costs are increased.

The present invention is made in view of the above problems, and provides a non-aqueous electrolyte secondary battery capable of reducing defects in production and improving the safety, by achieving a smooth removal of the winding core.

### Solution to Problem

One aspect of the present invention relates to a non-aqueous electrolyte secondary battery including: a non-aqueous electrolyte; and an electrode assembly which includes a positive electrode including a belt-like (sheet- or strip-like) positive electrode current collector and a positive electrode active material layer adhering to a surface of the positive electrode current collector, a negative electrode including a belt-like (sheet- or strip-like) negative electrode current collector and a negative electrode active material layer adhering to a surface of the negative electrode current collector, and a separator for insulating the positive electrode from the negative electrode, the positive electrode, the negative electrode, and the separator being spirally wound together. The separator includes a heat resistant porous film including a heat resistant resin, a first polyolefin porous film covering entirely a surface of the heat resistant porous film on the positive electrode side, and a second polyolefin porous film covering entirely a surface of the heat resistant porous film on the negative electrode side. The heat resistant resin has a melting point or a heat deflection temperature higher than those of polyolefins included in the first polyolefin porous film and the second polyolefin porous film. The heat resistant porous film has a thickness of 1 to 16 μm, the first polyolefin porous film has a thickness of 2 to 17 μm, the second polyolefin porous film has a thickness of 2 to 17 μm, and the separator has a thickness of 5 to 35 μm.

Another aspect of the present invention relates to a method for producing a non-aqueous electrolyte secondary battery, the method comprising the steps of:

preparing the above separator;

preparing a positive electrode including a belt-like (sheet- or strip-like) positive electrode current collector and a positive electrode active material layer adhering to a surface of the positive electrode current collector, and a negative electrode including a belt-like (sheet- or strip-like) negative electrode current collector and a negative electrode active material layer adhering to a surface of the negative electrode current collector;

clamping one end of the separator in a longitudinal direction thereof with a pair of winding cores, and winding spirally the positive electrode, the negative electrode, and the separator disposed so as to insulate the positive electrode from the negative electrode, to form an electrode assembly;

removing the winding cores from the electrode assembly; and

putting the electrode assembly and a non-aqueous electrolyte into a battery case.

While the novel features of the invention are set forth particularly in the appended claims, the invention, both as to organization and content, will be better understood and appreciated, along with other objects and features thereof, from the following detailed description taken in conjunction with the drawings.

### Advantageous Effects of Invention

According to the present invention, although the separator has an excellent heat resistance, a winding core can be smoothly removed from an electrode assembly that has been wound by using the winding core. This makes it possible to effectively suppress the displacement of or damage to the separator. Therefore, a non-aqueous electrolyte secondary battery excellent in safety can be provided with high productivity and fewer defects in production.

### BRIEF DESCRIPTION OF DRAWINGS

FIG. 1 A partially cut-away perspective view showing an example of a non-aqueous electrolyte secondary battery of the present invention.

FIG. 2 A cross-sectional schematic view showing an arrangement of a separator having a three-layer structure, a positive electrode, and a negative electrode in one embodiment of the non-aqueous electrolyte secondary battery.

FIG. 3 A cross-sectional schematic view showing an arrangement of a separator having a three-layer structure, a positive electrode, and a negative electrode in another embodiment of the non-aqueous electrolyte secondary battery.

FIG. 4 A cross-sectional schematic view showing an arrangement of a separator having a four-layer structure, a positive electrode, and a negative electrode in yet another embodiment of the non-aqueous electrolyte secondary battery.

FIG. 5 A cross-sectional schematic view showing an arrangement of a separator having a five-layer structure, a positive electrode, and a negative electrode in still another embodiment of the non-aqueous electrolyte secondary battery.

FIG. 6 A cross-sectional schematic view showing an arrangement of a separator having a three-layer structure, a positive electrode, and a negative electrode used in Comparative Example.

FIG. 7 A cross-sectional schematic view showing another arrangement of a separator having a three-layer structure, a positive electrode, and a negative electrode used in Comparative Example.

FIG. 8 A cross-sectional schematic view showing an arrangement of a separator having a two-layer structure, a positive electrode, and a negative electrode used in Comparative Example.

### DESCRIPTION OF EMBODIMENTS

A non-aqueous electrolyte secondary battery of the present invention includes: a non-aqueous electrolyte; and an electrode assembly including a belt-like positive electrode, a belt-like negative electrode, and a belt-like separator for insulating the positive electrode from the negative electrode, the positive electrode, the negative electrode, and the separator being spirally wound together. The electrode assembly is formed by winding the positive electrode, the negative electrode, and the separator, by using a winding core. More specifically, the positive electrode, the separator, and the negative electrode are stacked with the separator being interposed between the positive electrode and the negative electrode, in such a state that an end of the separator protrudes in the longitudinal direction thereof. The protruding end of the separator is clamped between a pair of winding cores, and in this state, the positive electrode, negative electrode, and separator stacked together are wound, whereby a spirally-wound electrode assembly is formed.

Prior to winding, a separator is prepared, the separator including: a heat resistant porous film including a heat resistant resin; a first polyolefin porous film covering entirely one surface of the heat resistant porous film; and a second polyolefin porous film covering entirely the other surface of the heat resistant porous film. The winding is performed in such a state that the first polyolefin porous film is arranged on the positive electrode side, and the second polyolefin porous film is arranged on the negative electrode side. The winding cores are removed from the electrode assembly after the winding, and therefore, in general, the electrode assembly in secondary batteries includes no winding core.

(Separator)

The separator includes a heat resistant porous film including a heat resistant resin, a first polyolefin porous film covering entirely a surface of the heat resistant porous film on the positive electrode side, and a second polyolefin porous film covering entirely a surface of the heat resistant porous film on the negative electrode side.

The heat resistant porous film has a higher heat resistance than the first and second polyolefin porous films. Specifically, the heat resistant resin included in the heat resistant porous film has a melting point or a heat deflection temperature higher than those of polyolefins included in the first and second polyolefin porous films. The heat resistant resin may be a resin which is sufficiently high in all of the glass transition point, the melting point, and the temperature at which thermal decomposition with chemical change starts. As the heat deflection temperature, for example, a deflection temperature under load may be used.

Specifically, an example of the heat resistance resin is a resin whose heat deflection temperature calculated under a load of 1.82 MPa in the measurement of deflection temperature under load according to the test method ASTM-D648 standardized by the American Society for Testing and Materials is 260° C. or higher. The upper limit of the heat deflection temperature is not particularly limited, but is about 400° C. in view of the properties of the separator and the thermal decomposition property of the resin. The higher the heat deflection temperature is, the more easily the shape of the separator is maintained even when, for example, the polyolefin porous film is shrunk by heat. A resin having a heat deflection temperature of 260° C. or higher enables the separator to exhibit a sufficiently excellent thermal stability even when the battery temperature is elevated (usually up to about 180° C.) by the heat accumulated during overheating.

Examples of the heat resistant resin include: aromatic polyamides (e.g., wholly aromatic polyamides) such as polyarylates and aramids; polyimide resins such as polyimides, polyamide-imides, polyether-imides, and polyester-imides; aromatic polyesters such as polyethylene terephthalate; polyphenylene sulfide; polyether nitriles; polyether ether ketones; and polybenzimidazole. These heat resistant resins may be used singly or in combination of two or more. Preferred examples thereof include aramids, polyimides, and polyamide-imides, in view of the non-aqueous electrolyte retaining ability and the heat resistance.

The heat resistant porous film may further include an inorganic filler, as needed, in order to further improve the heat resistance. Examples of the inorganic filler include: metals or metal oxides such as iron powder and iron oxide; ceramics such as silica, alumina, titania, and zeolite; mineral-based fillers such as talc and mica; carbon-based fillers such as activated carbon and carbon fiber; carbides such as silicon carbide; nitrides such as silicon nitride; and glass fibers, glass beads, and glass flakes. The inorganic filler may be in any form, without particular limitation, such as in a particulate or powdery form, a fibrous form, a flake form, and a massive form. These inorganic fillers may be used singly or in combination of two or more.

The ratio of the inorganic filler(s) per 100 parts by weight of the heat resistant resin is, for example, 50 to 400 parts by weight, and preferably 80 to 300 parts by weight. As the ratio of the inorganic filler(s) is increased, the hardness and friction coefficient of the heat resistant porous film become higher, and the slidability thereof becomes poorer. However, in the present invention, the heat resistant porous film is sandwiched between the first and second polyolefin porous films. As such, if the ratio of the inorganic filler(s) is high, it is possible to impart the separator with excellent heat resistance without sacrificing the windability and the removability of the winding core.

The thickness of the heat resistant porous film is 1 to 16 μm, and preferably 2 to 10 μm, in view of the balance between the safety against internal short circuit and the battery capacity. When the thickness is too small, the effect to prevent shrinkage by heat of the first and second polyolefin porous films in a high temperature environment is reduced. If the thickness is too large, the impedance of the heat resistant porous film is increased because the porosity and ion conductivity thereof are comparative low, causing the charge/discharge characteristics to deteriorate, even though slightly.

The porosity of the heat resistant porous film is, for example, 20 to 70%, and preferably 25 to 65%, in view of sufficiently ensuring the movability of lithium ions.

In view of the removability of the winding core, the first and second polyolefin porous films are arranged so as to be present at the portion where the separator is in contact with the winding core. In addition, it is preferable to entirely cover a surface of the heat resistant porous film on the positive electrode side with the first polyolefin porous film, and to cover entirely a surface of the heat resistant porous film on the negative electrode side with the second polyolefin porous film. In the separator as described above, the heat resistant porous film is not exposed on the surfaces thereof. As such, the winding core can be more smoothly removed from the electrode assembly. Further, the component elements of the electrode assembly are easily aligned as compared to when a polyolefin porous film is formed only at the winding start portion, and therefore, the winding displacement of the component elements of the electrode assembly (i.e., the positive electrode, the negative electrode, and the separator) can be more effectively suppressed.

Examples of the polyolefins constituting the first and second polyolefin porous films include polyethylene, polypropylene, and ethylene-propylene copolymer. These resins may be used singly or in combination of two or more. Another thermoplastic polymer may be used in combination with polyolefin, as needed.

The first and second polyolefin porous films may be a porous film of polyolefin, or a woven or non-woven fabric made of polyolefin fibers. Here, a porous film is formed by, for example, forming a molten resin into sheet, and uniaxially or biaxially stretching the sheet. Each of the first and second polyolefin porous films may be of a single layer (i.e., a porous film composed of a single porous polyolefin layer) or include two or more porous polyolefin layers. The first polyolefin porous film may be the same as or different from the second polyolefin porous film.

When the first or second polyolefin porous film includes two or more porous polyolefin layers, it may be a laminate of two or more layers having compositions different from each other, or a laminate of a woven or non-woven fabric and a porous film. In the first and/or second polyolefin porous film, another (a second) heat resistant porous film may be interposed between the two or more porous polyolefin layers, as needed. Examples of another heat resistant porous film are the same as those of the above-described heat resistant porous film.

The number of porous polyolefin layers in the first or second polyolefin porous film is not particularly limited, but is, for example, one, two or three layers, and preferably one or two layers.

The number of porous polyolefin layers in the first polyolefin porous film may be different from that in the second polyolefin porous film, but is preferably the same. In a preferred embodiment, both of the first and second polyolefin porous films have a single porous polyolefin layer, or both of them have two porous polyolefin layers.

Each of the first and second polyolefin porous films preferably includes a porous polyethylene layer or a porous polypropylene layer as the above porous polyolefin layer. For example, the first polyolefin porous film may be a porous film composed of a single porous polypropylene layer, or a porous film composed of two or more porous polyolefin layers with an outermost surface layer being a porous polypropylene layer. Further, the second polyolefin porous film may be a porous film composed of a single porous polyethylene layer, or a porous film composed of two or more porous polyolefin layers with an outermost surface layer being a porous polyethylene layer.

A polyolefin porous film with an outermost surface layer being a porous polyethylene layer (including a polyolefin porous film composed of a single porous polyethylene layer) has an appropriate shutdown temperature, and high in safety. However, the stability thereof is poor at a charge potential of the positive electrode, and therefore, it is considered that a decomposition involving consumption of the non-aqueous electrolyte occurs under exposure to a high temperature over a long period of time. For this reason, it is preferable to use such a polyolefin porous film as the second polyolefin porous film, and to use a polyolefin porous film with an outermost surface layer being a porous polypropylene layer (including a polyolefin porous film composed of a single porous polypropylene layer) as the first polyolefin porous film. A separator having a layer configuration as described above can stably exhibit the shutdown function.

The first and second polyolefin porous films each independently have a thickness of 2 to 17 μm, and preferably 3 to 10 μm, in view of the removability of the winding cores and the shutdown property. The heat resistant porous film is higher in hardness than the polyolefin porous film, and therefore, the total of the thicknesses of the first and second polyolefin porous films is preferably larger than the thickness of the heat resistant porous film. However, if the thickness of the polyolefin porous film is too large, there is a possibility that the polyolefin porous film shrinks greatly when exposed to a high temperature, and the heat resistant layer contracts as the polyolefin porous film shrinks, to cause the electrode lead portion to be exposed. The total of the thicknesses of the first and second polyolefin porous films is, for example, 1.5 to 8 times, preferably 2 to 7 times, and more preferably 3 to 6 times as large as the thickness of the heat resistant porous film.

The porosity in the first or second polyolefin porous film (or the porous polyolefin layer(s)) is, for example, 20 to 80%, and preferably 30 to 70%. The average pore diameter in the first or second polyolefin porous film (or the porous polyolefin layer(s)) is selectable from the range of 0.01 to 10 μm, and is preferably 0.05 to 5 μm, in view of providing ion conductivity and mechanical strength.

The first and second polyolefin porous films are low in hardness and low in friction coefficient as compared to the heat resistant porous film. For this reason, arranging the first and second polyolefin porous films on the surfaces of the heat resistant porous film makes it possible to remove winding core smoothly from an electrode assembly formed as described above by using the winding core. Therefore, the separator will not be displaced or damaged by the removal of the winding core. As a result, it is possible to effectively suppress the occurrence of leakage defect and thus the reduction in yield. In addition to this effect, the presence of the heat resistant porous film and the first and second polyolefin porous films makes it possible to achieve the heat resistance and the shutdown property at high levels.

In the separator as described above, the coefficient of static friction on the surfaces of the first and second polyolefin porous films is 0.08 to 0.18, and preferably 0.09 to 0.17. When a polyolefin porous film having a coefficient of static friction within the foregoing ranges is used, the winding core can be extremely smoothly removed. The coefficient of static friction can be measured by a method according to ASTM (D1894), with an instrument provided with a load cell, specifically by placing a separator with a weight attached thereto on the test table, and measuring a force required for pulling the weight.

The surface roughness of the first and second polyolefin porous films is preferably smaller than that of the winding core. Assuming that the surface roughness (the arithmetic average roughness Ra) of the winding core is 1, the surface roughness (the arithmetic average roughness Ra) of the first and second polyolefin porous films is, for example, 0.1 to 0.9, and more preferably 0.2 to 0.5.

In view of smooth removal of the winding cores, the displacement of the orientation direction of polyolefin molecules at the surface of the polyolefin porous film from the removal direction (the direction along the long axis of the winding core) is preferably small. The displacement of the orientation direction of polyolefin molecules at the surface from the removal direction is, for example, 0 to 45°, and preferably is 0 to 30°. The orientation direction of polyolefin molecules at the surface of the polyolefin porous film can be adjusted by adjusting the draw ratio, stretch ratio, and the like in film formation in the process of producing a porous film. For example, when uniaxial stretching is used to form a polyolefin porous film or porous polyolefin layer, the polyolefin porous film or porous polyolefin layer is arranged such that the displacement of the stretching direction from the winding core removal direction falls within the foregoing ranges, because the polyolefin molecules are oriented along the stretching direction. When biaxial stretching is used to form a polyolefin porous film or porous polyolefin layer, the stretch ratio is changed in each stretching direction so that the polyolefin molecules can be oriented along the direction in which the stretch ratio is high.

The thickness of the separator, for example, can be selected from the range of 5 to 35 μm, and preferably may be 10 to 30 μm, or 12 to 20 μm. When the thickness of the separator is too small, a minor short circuit is likely to occur in the battery; and when it is too large, the thicknesses of the positive and negative electrodes may need to be decreased, failing to provide a sufficient battery capacity.

The heat resistant porous film and the first and second polyolefin porous films may be formed separately, and laminated together to produce a separator. One of the porous films may be formed first, and then the other porous films may be formed on the surface(s) of the first-formed porous film. A separator having a layered structure can be directly formed from component materials of each porous film by coextrusion or the like. These methods may be combined as appropriate. In laminating the porous films together, a known adhesive and a known welding method (e.g., thermal welding) may be used, as needed.

A preferred method is a combination of: coating by using a solution or dispersion of component materials of a porous film; and laminating with a porous film produced by a known method. For example, first and second polyolefin porous films are formed separately by a known porous film production method, and then on the surface of one of the polyolefin porous films, a solution or dispersion including component materials of a heat resistant porous film (a heat resistant resin such as an aramid, and, as needed, an inorganic filler, a pore-forming agent such as calcium chloride, and the like) is applied, followed by drying, as needed. Subsequently, the other polyolefin porous film is laminated on the applied surface (i.e., the surface of the heat resistant porous film). In such a manner, a separator can be formed. The separator is washed with water, as needed, to allow the pore-forming agent to be leached out.

The layer-to-layer adhesion can be improved by laminating the polyolefin porous film on the applied surface before the applied solution or dispersion is completely dried. By using the separator thus formed, in which the heat resistant porous film and the first and second polyolefin films are integrated together, it is possible to effectively suppress the displacement of or damage to the separator which may occur as the winding core is being removed.

In the case of using a polyimide or polyamide-imide as the heat resistant resin, the separator can be prepared in the following manner.

First, a polyamic acid solution, which is a precursor, is flow-casted, and then stretched, to form a porous film. The first and second polyolefin porous films are placed on both surfaces of the resultant porous film, respectively. Then, these are integrated together (e.g., integrated together by heat rolling) at such a temperature that the pores of the polyolefin porous films will not be shut down (i.e., a temperature lower than the melting temperature), whereby a separator can be formed. The heat rolling allows imidization of polyamic acid to proceed, causing the polyamic acid in the porous film to be converted into a polyimide or polyamide-imide. If necessary, the polyamic acid porous film may be heated before placing the polyolefin porous films thereon, to convert the polyamic acid into a polyimide or polyamide-imide. In this method, the porosity in the heat resistant porous film can be adjusted by changing the condition for stretching.

In the case where the first or second polyolefin porous film has two or more porous polyolefin layers, the polyolefin porous film may be formed beforehand by utilizing, for example, a known method such as coextrusion. Two polyolefin porous films are prepared, and then, on one of the polyolefin porous films, a heat resistant porous film is formed by application as described above, on which the other polyolefin porous film is laminated. A method similar to or in accordance with this method may be employed to form a separator including a polyolefin porous film having three or more porous polyolefin layers.

Examples of the solvent in which the component materials of a heat resistant porous film are dissolved or dispersed include: alcohols such as methanol, ethanol, and ethyleneglycol (e.g., C₂₋₄ alkanol, or C₂₋₄ alkanediol); ketones such as acetone; ethers such as diethyl ether and tetrahydrofuran; amides such as dimethylformamide; nitriles such as acetonitrile; sulfoxides such as dimethylsulfoxide; and N-methyl-2-pyrrolidone (NMP). These solvents may be used singly or in combination of two or more.

The separator may contain a commonly used additive (e.g., an antioxidant). The additive may be contained in any of the heat resistant porous film and the first and second polyolefin porous films. For example, the antioxidant may be contained in the first and/or second polyolefin porous film. In the case where the polyolefin porous film has two or more porous polyolefin layers, the antioxidant may be contained in the outermost surface layer. When the antioxidant is contained in the surface layer of the separator, the oxidation resistance of the polyolefin porous film (or the porous polyolefin layer(s)) can be improved. An exemplary antioxidant is at least one selected from the group consisting of a phenolic antioxidant, a phosphoric acid-series antioxidant, and a sulfur-containing antioxidant. A phenolic antioxidant may be used in combination with a phosphoric acid-series antioxidant or a sulfur-containing antioxidant. A sulfur-containing antioxidant is highly compatible with polyolefin, and therefore, is preferably contained in the polyolefin porous film (e.g., the polypropylene porous film).

Examples of the phenolic antioxidant include: hindered phenol compounds such as 2,6-di-t-butyl-p-cresol, 2,6-di-t-butyl-4-ethylphenol, triethyleneglycol bis[3-(3-t-butyl-5-methyl-4-hydroxyphenyl)propionate], and n-octadecyl 3-(3,5-di-t-butyl-4-hydroxyphenyl)propionate. Examples of the sulfur-containing antioxidant include: dilauryl thiodipropionate, distearyl thiodipropionate, and dimyristyl thiodipropionate. Preferred examples of the phosphoric acid-series antioxidant include tris(2,4-di-t-butylphenyl)phosphite.

Now referring to the appended drawings, the non-aqueous electrolyte secondary battery of the present invention is described.

FIG. 1 is a partially cut-away perspective view showing the configuration of a cylindrical lithium ion secondary battery according to one embodiment of the present invention. The lithium ion secondary battery of FIG. 1 includes an electrode assembly 14 formed by winding a strip-like positive electrode 5 and a strip-like negative electrode 6 with a separator 7 interposed therebetween, the electrode assembly 14 being accommodated together with a non-aqueous electrolyte (not shown) in a bottomed cylindrical battery case 1 made of metal. The positive electrode 5 includes a positive electrode current collector made of metal foil, and a positive electrode active material layer adhering to a surface thereof. The negative electrode 6 includes a negative electrode current collector made of metal foil, and a negative electrode active material layer adhering to a surface thereof.

In the electrode assembly 14, a positive electrode lead terminal 5a is electrically connected to the positive electrode 5, and a negative electrode lead terminal 6a is electrically connected to the negative electrode 6. The electrode assembly 14 is put into the battery case 1 together with a lower insulating plate 9, while the positive electrode lead terminal 5a is extended. The end of the positive electrode lead terminal 5a is welded to a sealing plate 2. The sealing plate 2 has a positive electrode terminal 12 and a safety mechanism including a PTC element and an explosion prevention valve (not shown).

The lower insulating plate 9 is disposed between the bottom surface of the electrode assembly 14 and the negative electrode lead terminal 6a extended downward from the electrode assembly 14. The negative electrode lead terminal 6a is welded to the inner bottom surface of the battery case 1. An upper insulating ring (not shown) is placed on the top surface of the electrode assembly 14. An inwardly protruding step portion is formed on an upper portion of the side surface of the battery case 1 at a position above the upper insulating ring. This serves to hold the electrode assembly 14 inside the battery case 1. Subsequently, a predetermined amount of non-aqueous electrolyte is injected into the battery case 1. The positive electrode lead terminal 5a is bent and accommodated in the battery case 1. On the step portion is placed the sealing plate 2 provided with a gasket 13 on the peripheral portion thereof. The battery case 1 is sealed by crimping the opening end thereof inwardly, whereby a cylindrical lithium ion secondary battery is fabricated.

The electrode assembly 14 is formed by stacking the positive electrode 5, the separator 7, the negative electrode 6, and another separator 7 in this order, winding these spirally by using winding cores (not shown), and then removing the winding cores. The component elements of the electrode assembly 14 (the positive electrode 5, the negative electrode 6, and the separators 7) are stacked in such a state that the ends of the two separators 7 protrude from the ends of the positive electrode 5 and the negative electrode 6 in the longitudinal direction thereof. The protruding ends of the separators 7 are clamped with a pair of winding cores, and in this state, the component elements of the electrode assembly 14 are wound. Several rounds from the start of winding (e.g., the first to third rounds of winging) may be in such a state that only the two separators 7 are wound. The portion in which only the separators 7 are wound is shown in FIG. 1, as a separator portion 16.

Upon completion of winding, the clamping of the separators 7 with the pair of winding cores is loosened, to remove the winding cores. In order to allow the winding cores to be easily removed, the clamping with the winding cores may be loosened by turning the winding cores slightly in the direction opposite to the winding direction. The winding cores are composed of two members so that the separators 7 can be clamped therebetween, and the portions of these members at which the separators 7 are clamped are flat so that the separators 7 can be held therebetween.

The separator 7 has a heat resistant porous film serving as the intermediate layer, and first and second polyolefin porous films serving as the surface layers disposed on both surfaces of the heat resistant porous film. In the separator thus configured, the heat resistant porous film is not exposed on the front and back surfaces (in particular, the front and back surfaces of the portion which comes in contact with the winding cores). As such, the surface slidability is excellent, which reduces the contact resistance between the winding core and the separator 7, allowing the winding cores to be smoothly removed.

The foregoing separator is useful in forming an electrode assembly by winding, at a high tension, together with a positive or negative electrode in which the filling amount of positive or negative electrode active material is large. For example, the above separator is preferably used for 18650-type high capacity cylindrical battery, because the nominal capacity of the battery is 1800 mA or more, and preferably 2000 mA or more.

In the case of winding a separator together with a positive or negative electrode in which the filling amount of active material is increased, the outer diameter of the electrode assembly tends to be increased. In this case, in order to put the electrode assembly into a bottomed case having a specific volume, the separator must be wound at a high tension, while being clamped with a winding core, together with the positive and negative electrodes. Winding at a high tension, however, causes the winding core and the separator to strongly adhere to each other. Accordingly, the adhesion between the separator portion at the winding start portion and the winding core is strong, and therefore, separator displacement is likely to occur as the winding core is being removed. Even in such an electrode assembly, by using a separator in which the first and second polyolefin porous films are disposed at the surface layers, the winding core can be extremely smoothly removed.

Although a cylindrical electrode assembly is described by referring to FIG. 1, the wound electrode assembly may be a flat electrode assembly whose end surface perpendicular to the winding axis is of an elliptic shape.

The electrode assembly 14 is dried before or after it is put into the battery case 1. A preferable drying condition is a low humidity and high temperature atmosphere. However, if the temperature is too high, there is a possibility that the separator 7 shrinks by heat and the micropores are closed. When this happens, the porosity and the Gurley number change, causing a detrimental effect on the battery characteristics. For this reason, the drying is preferably performed under the conditions of a dew point being −30° C. to −80° C. and a temperature being 80 to 120° C.

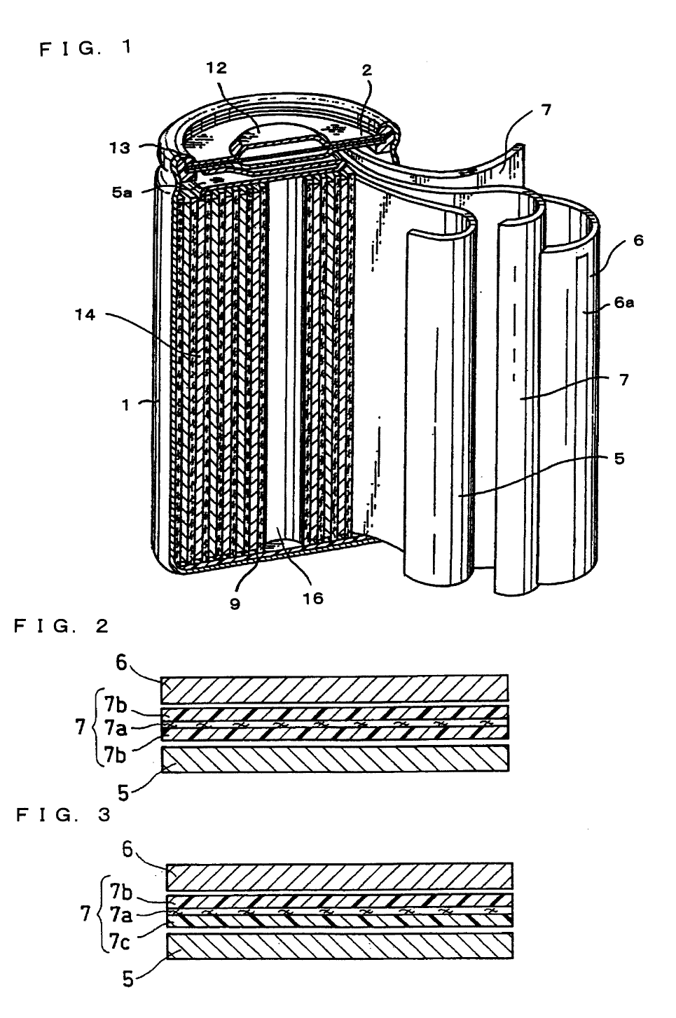

FIGS. 2 to 5 are cross-sectional schematic views showing embodiments of the separator 7. In FIG. 2, the separator 7 interposed between the positive electrode 5 and the negative electrode 6 has a three-layer structure having a heat resistant porous film 7a serving as the intermediate layer and polyethylene porous films 7b which are formed on both surfaces of the heat resistant porous film 7a and each composed of a single porous polyethylene layer. Both surfaces of the heat resistant porous film 7a are entirely covered with the polyethylene porous films 7b.

FIGS. 3 to 5 show modified examples of FIG. 2. In the separator 7 of FIG. 3, one surface of the heat resistant porous film 7a serving as the intermediate layer is entirely covered with the polyethylene porous film 7b, and the other surface thereof is entirely covered with a polypropylene porous film 7c composed of a single porous polypropylene layer. The polypropylene porous film 7c faces the positive electrode 5.

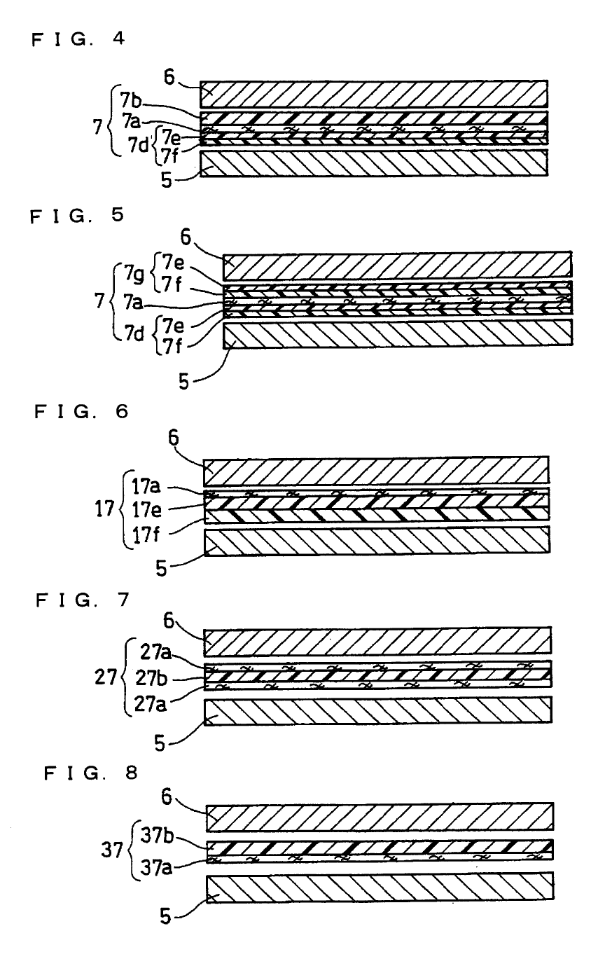

In the separator 7 of FIG. 4, on the surface in the negative electrode 6 side of the heat resistant porous film 7a serving as the intermediate layer, the polyethylene porous film 7b is disposed; and on the surface thereof in the positive electrode 5 side, a porous polyethylene layer 7e and a porous polypropylene layer 7f are disposed in this order, forming a first polyolefin porous film 7d. The porous polypropylene layer 7f positioned at the outermost surface layer faces the positive electrode 5.

In the separator 7 of FIG. 5, polyolefin porous films 7d and 7g each having a two-layer structure composed of a porous polyethylene layer 7e and a porous polypropylene layer 7f are formed on both surfaces of the heat resistant porous film 7a serving as the intermediate layer. The surface of the heat resistant porous film 7a in the positive electrode 5 side is in contact with the porous polypropylene layer 7f, and the surface thereof in the negative electrode 6 side is in contact with the porous polyethylene layer 7e.

All of the separators 7 as configured above have surface layers made of a polyolefin porous film with good slidability. As such, even when the separator 7 is clamped with a winding core and wound together with the positive electrode 5 and the negative electrode 6, the winding core can be smoothly removed, and while being removed, will not cause the separator to be displaced or damaged. Further, by disposing the first and second polyolefin porous films on the entire surfaces of the heat resistant porous film, as compared to by disposing them only at the winding start portion, alignment is easily performed, and winding displacement that may occur in association with winding can be effectively suppressed. Therefore, product defects involving current leakage (leakage defects) can be reduced, and thus the decrease in yield due to such defects can be suppressed. In addition, because of an appropriate shutdown effect and excellent heat resistance of the separator, a sufficient safety against heat can be ensured, and thus a highly reliable non-aqueous electrolyte secondary battery can be obtained. By disposing the porous polypropylene layer at the outermost surface layer so as to face the positive electrode, the oxidation at the surface of separator can be suppressed.

Each component element of the present invention is more specifically described below.

(Positive Electrode)

The positive electrode includes a belt-like (sheet- or strip-like) positive electrode current collector and a positive electrode active material layer adhering to the surface of the positive electrode current collector. The positive electrode current collector may be any known positive electrode current collector for use in non-aqueous electrolyte secondary batteries, such as a metal foil made of, for example, aluminum, aluminum alloys, stainless steel, titanium, or titanium alloys. The material for the positive electrode current collector may be selected as appropriate in view of the processability, practical strength, adhesion with the positive electrode active material layer, electron conductivity, corrosion resistance, and other factors. The thickness of the positive electrode current collector is, for example, 1 to 100 μm, and preferably 10 to 50 μm.

The positive electrode active material layer may contain a conductive agent, binder, thickener, and the like, in addition to the positive electrode active material. The positive electrode active material may be, for example, a lithium-containing transition metal compound capable of accepting lithium ions as a guest. Examples thereof include: composite metal oxides containing lithium and at least one metal selected from the group consisting of cobalt, manganese, nickel, chromium, iron, and vanadium, such as LiCoO₂, LiMn₂O₄, LiCOₓNi₍₁₋ₓ₎O₂ (0<x<1), LiCO_{y}M_{1-y}O₂ (0.6≦y<1), LiNi_{z}M_{1-z}O₂ (0.6≦z<1), LiCrO₂, αLiFeO₂, and LiVO₂. In the above compositional formulae, M is at least one element (in particular, Mg and/or Al) selected from the group consisting of Na, Mg, Sc, Y, Mn, Fe, Co, Ni, Cu, Zn, Al, Cr, Pb, Sb and B. These positive electrode active materials may be used singly or in combination of two or more.

The binder is not particularly limited as long as it can be dissolved or dispersed in a dispersion medium by kneading. Examples of the binder include fluorocarbon resins, rubbers, or acrylic polymers or vinyl polymers (e.g., homo- or co-polymers of an acrylic monomer such as methyl acrylate and acrylonitrile, a vinyl monomer such as vinyl acetate, or the like). Examples of fluorocarbon resins include polyvinylidene fluoride, vinylidene fluoride-hexafluoropropylene copolymer, and polytetrafluoroethylene. Examples of rubbers include acrylic rubber, modified acrylonitrile rubbers, and styrene-butadiene rubber (SBR). These binders may be used singly or in combination of two or more. The binder may be in the form of a dispersion in which the binder is dispersed in a dispersion medium.

Examples of the conductive agent include: carbon black such as acetylene black, Ketjen black, channel black, furnace black, lamp black, and thermal black; various graphites such as natural graphite and artificial graphite; and conductive fibers such as carbon fibers and metal fibers.

A thickener may be added as needed. Examples of the thickener include ethylene-vinyl alcohol copolymer and cellulose derivatives (e.g., carboxymethylcellulose and methylcellulose).

The dispersion medium is not particularly limited as long as the binder can be dissolved or dispersed therein, and may be an organic solvent or water (including warm water) depending on the affinity of the binder to the dispersion medium. Examples of the organic solvent include: N-methyl-2-pyrrolidone; ethers such as tetrahydrofuran; ketones such as acetone, ethyl methyl ketone, and cyclohexanone; amides such as N,N-dimethylformamide and dimethylacetamide; sulfoxides such as dimethylsulfoxide; and tetramethylurea. These dispersion mediums may be used singly or in combination of two or more.

The positive electrode active material layer can be formed by kneading a positive electrode active material, and, as needed, a binder, a conductive agent, and/or a thickener, together with a dispersion medium, to prepare a material mixture in the state of slurry, and allowing the material mixture to adhere to a positive electrode current collector. Specifically, the positive electrode active material layer can be formed by applying the material mixture on the surface of a positive electrode current collector by a known coating method, followed by drying and, as needed, rolling. The positive electrode current collector has a portion where no positive electrode active material layer is formed and the surface of the current collector is exposed. A positive electrode lead is welded to this exposed portion. The positive electrode is preferably excellent in flexibility.

The material mixture may be applied by using a known coater, such as a slit die coater, reverse roll coater, lip coater, blade coater, knife coater, gravure coater, and dip coater. The drying after application is preferably performed under the condition similar to that for natural drying, but, in view of the productivity, may be performed at a temperature in the range of 70° C. to 200° C. for 10 minutes to 5 hours. The rolling of the active material layer can be performed, for example, by repeating rolling several times with a roll press machine until a predetermined thickness is obtained, under the condition of a line pressure being 1000 to 2000 kgf/cm (19.6 kN/cm). The line pressure may be changed, as needed, to perform the rolling.

In kneading into a material mixture in the state of slurry, various dispersion agents, surfactants, and stabilizers may be added, as needed.

The positive electrode active material layer may be formed on one surface or both surfaces of the positive electrode current collector. When a lithium-containing transition metal compound is used as the active material, the density of the active material in the positive electrode active material layer is 3 to 4 g/ml, and preferably 3.4 to 3.9 g/ml and 3.5 to 3.7 g/ml.

The thickness of the positive electrode is, for example, 70 to 250 μm, and preferably 100 to 210 μm.

(Negative Electrode)

The negative electrode includes a belt-like (sheet- or strip-like) negative electrode current collector and a negative electrode active material layer adhering to the surface of the negative electrode current collector. The negative electrode current collector may be any known negative electrode current collector for use in non-aqueous electrolyte secondary batteries, such as a metal foil made of, for example, copper, copper alloy, nickel, nickel alloy, stainless steel, aluminum, or aluminum alloy. Preferred examples of the negative electrode current collector include copper foil and metal foil made of copper alloy, in view of the processability, practical strength, adhesion with the positive electrode active material layer, electron conductivity, and other factors. The current collect may be in any form without limitation, and may be, for example, in the form of rolled foil or electrolytic foil, or in the form of mesh foil, expanded material or lath material. The thickness of the negative electrode current collector is preferably 1 to 100 μm, and more preferably 2 to 50 μm.

The negative electrode active material layer may contain a conductive agent, binder, thickener, and the like, in addition to the negative electrode active material. An example of the negative electrode active material is a material having a graphite-like crystal structure capable of reversibly absorbing and releasing lithium ions. Examples of such material include carbon materials such as natural graphite, spherical or fibrous artificial graphite, non-graphitizable carbon (hard carbon), and graphitizable carbon (soft carbon). Particularly preferred is a carbon material having a graphite-like crystal structure in which the interplanar spacing (d002) of the lattice plane (002) is 0.3350 to 0.3400 nm. Further examples of the negative electrode active material include: silicon; silicon-containing compounds such as silicide; lithium alloys or various alloy materials containing at least one selected from tin, aluminum, zinc, and magnesium.

An example of silicon-containing compounds is a silicon oxide SiO_{α} (0.05<α<1.95). The value of α is preferably 0.1 to 1.8, and more preferably 0.15 to 1.6. In the silicon oxide, part of silicon may be substituted by one element or two or more elements. Examples of such elements include B, Mg, Ni, Co, Ca, Fe, Mn, Zn, C, N and Sn.

Examples of the binder, conductive agent, thickener and dispersion medium are the same as those listed for the positive electrode.

The negative electrode active material layer can be formed not only by the above-described coating using a binder and the like but also by a known method. For example, it may be formed by depositing a negative electrode active material on the surface of the current collector by a vapor phase method such as vacuum vapor deposition, sputtering, or ion plating. Alternatively, it may be formed by the same method as used for forming a positive electrode active material layer, using a material mixture in the state of slurry containing a negative electrode active material, a binder, and as needed, a conductive material.

The negative electrode active material layer may be formed on one surface of the negative electrode current collector or on both surfaces thereof. The density of the active material in the negative electrode active material layer formed by using a material mixture including a carbon material as the active material is 1.3 to 2 g/ml, preferably 1.4 to 1.9 g/ml, and more preferably 1.5 to 1.8 g/ml.

The thickness of the negative electrode is, for example, 100 to 250 μm, and preferably 110 to 210 μm. A negative electrode having flexibility is preferred.

The non-aqueous electrolyte is prepared by dissolving a lithium salt in a non-aqueous solvent. Examples of the non-aqueous solvent include: cyclic carbonates such as ethylene carbonate, propylene carbonate, and butylene carbonate; chain carbonates such as dimethyl carbonate and diethyl carbonate; lactones such as γ-butyrolactone; halogenated alkanes such as 1,2-dichloroethane; alkoxy alkanes such as 1,2-dimethoxyethane and 1,3-dimethoxypropane; ketones such as 4-methyl-2-pentanone; ethers such as 1,4-dioxan, tetrahydrofuran, and 2-methyltetrahydrofuran; nitriles such as acetonitrile, propionitrile, butyronitrile, valeronitrile, and benzonitrile; sulfolane and 3-methyl-sulfolane; amides such as dimethylformamide; sulfoxides such as dimethylsulfoxide; and alkyl phosphate such as trimethyl phosphate and triethyl phosphate. These non-aqueous solvents may be used singly or in combination of two or more.

An example of the lithium salt is a lithium salt having a strong electron-withdrawing ability, such as LiPF₆, LiBF₄, LiClO₄, LiAsF₆, LiCF₃SO₃, LiN(SO₂CF₃)₂, LiN(SO₂C₂F₅)₂, and LiC(SO₂CF₃)₃. These lithium salts may be used singly or in combination of two or more. The concentration of the lithium salt in the non-aqueous solvent is, for example, 0.5 to 1.5 M, and preferably 0.7 to 1.2 M.

The non-aqueous electrolyte may further include an additive, as appropriate. For example, in order to form a favorable membrane on the positive and negative electrodes, vinylene carbonate (VC), cyclohexylbenzene (CHB), or a modified form of VC or CHB may be added. As an additive that acts when the lithium ion secondary battery falls in an overcharged state, for example, terphenyl, cyclohexylbenzene, or diphenyl ether may be added. These additives may be used singly or in combination of two or more. The ratio of the additive(s) is not particularly limited, but is, for example, about 0.05 to 10% by weight relative to the non-aqueous electrolyte.

The battery case may be made of, for example, a metal or a laminate film. In view of pressure resistant strength, the battery case is preferably made of, for example, an aluminum alloy containing a small amount of metal such as manganese or copper, and an inexpensive steel plate with nickel plating. The battery case may be of any shape such as cylindrical shape or prismatic shape, according to the shape of the electrode assembly.

The non-aqueous electrolyte secondary battery of the present invention is preferably used as 18650-type cylindrical battery and the like.

### EXAMPLES

Examples of the present invention are described below with reference to the appended drawings. It should be noted that the description here merely relates to illustrative examples of the present invention, and the present invention is not limited thereto.

### Example 1

(1) Production of Positive Electrode 5

To an appropriate amount of N-methyl-2-pyrrolidone, 100 parts by weight of lithium cobalt oxide serving as the positive electrode active material, 2 parts by weight of acetylene black serving as the conductive agent, and 3 parts by weight of polyvinylidene fluoride resin serving as the binder were added and kneaded together, to prepare a material mixture in the state of slurry. The slurry was intermittently and continuously applied onto both surfaces of a strip-like aluminum foil (thickness: 15 μm), and then dried. Subsequently, rolling was performed two to three times with rollers at a line pressure of 1000 kgf/cm (9.8 kN/cm), and the thickness was adjusted to 180 μm. The resultant product was cut in the size of 57 mm in width and 620 mm in length to produce a positive electrode 5 having a positive electrode active material layer on each surface thereof. The density of the active material in the positive electrode active material layer was 3.6 g/ml.

A positive electrode lead terminal 5a made of aluminum was ultrasonically welded to an exposed portion of the aluminum foil where no material mixture was applied. An electrically insulating tape made of polypropylene resin was stuck on the ultrasonically welded portion so as to cover the positive electrode lead terminal portion 5a.

(2) Production of Negative Electrode 6

To an appropriate amount of water, 100 parts by weight of flake graphite capable of absorbing and releasing lithium, serving as the negative electrode active material, 1 part by weight (solid basis) of an aqueous dispersion of styrene-butadiene rubber (SBR) serving as the binder, and 1 part by weight of sodium carboxymethylcellulose serving as the thickener were added and kneaded, to disperse these components to prepare a material mixture in the state of slurry. The slurry was intermittently and continuously applied onto both surfaces of a strip-like copper foil (thickness: 10 μm), and then dried at 110° C. for 30 minutes. Subsequently, rolling was performed two to three times with rollers at a line pressure of 110 kgf/cm (1.08 kN/cm), and the thickness was adjusted to 174 μm. The resultant product was cut in the size of 59 mm in width and 645 mm in length to produce a negative electrode 6 having a negative electrode active material layer on each surface thereof. The density of the active material in the negative electrode active material layer was 1.6 g/ml.

A negative electrode lead terminal 6a made of nickel was resistance-welded to an exposed portion of the copper foil where no material mixture was applied. An electrically insulating tape made of polypropylene resin was stuck on the resistance-welded portion so as to cover the negative electrode lead terminal portion 6a.

(3) Preparation of Separator 7

A separator 7 as shown in FIG. 2 having a three-layer structure composed of an aramid-containing heat resistant porous film 7a serving as the intermediate layer and two polyethylene porous films 7b sandwiching the intermediate layer was prepared. Specifically, an N-methyl-2-pyrrolidone (NMP) solution of aramid (including anhydrous calcium chloride as a pore-forming agent) was applied on one surface of a polyethylene porous film 7b (thickness: 8.5 μm) in such a ratio that the thickness of the separator became 20 μm. Before the solution was completely dried, another polyethylene porous film 7b (the same as above) was bonded to the applied surface, and dried. The resultant laminate was washed with water, and the anhydrous calcium chloride was removed therefrom to form micropores in the aramid-containing intermediate layer, followed by drying, whereby a belt-like separator 7 formed into a hoop was prepared. The resultant separator 7 was cut in the size of 60.9 mm in width, to be subjected to the formation of an electrode assembly.

The NMP solution of aramid was prepared as follows. First, a predetermined amount of dry anhydrous calcium chloride was added to an appropriate amount of NMP in a reaction bath, and heated to be dissolved completely. The resultant calcium chloride-added NMP solution was allowed to cool to room temperature, to which a predetermined amount of paraphenylendiamine (PPD) was added and dissolved completely. Subsequently, terephthalic acid dichloride (TPC) was added dropwise, to synthesize polyparaphenylene terephthalamide (PPTA) by polymerization reaction. Upon completion of reaction, the resultant polymerization solution was stirred for 30 minutes under reduced pressure, to be degassed. The polymerization solution was further diluted, as appropriate, with the calcium chloride-added NMP solution, whereby an aramid resin-dissolving NMP solution was prepared.

(4) Formation of Electrode Assembly 14

The positive electrode 5 and the negative electrode 6 were wound spirally with the separator 7 interposed therebetween, to form an electrode assembly 14. Specifically, the positive electrode 5, the separator 7, and the negative electrode 6 were stacked with the separator 7 being interposed between the positive electrode 5 and the negative electrode 6, such that an end of the separator 7 in the longitudinal direction thereof protrudes from the positive electrode 5 and the negative electrode 6. The protruding end of the separator was clamped with a pair of winding cores, and winding was performed by using the winding cores as a winding axis, whereby a spirally-wound electrode assembly 14 was formed. After the winding is finished, the separator was cut, and the clamping by the winding cores was loosened, to remove the winding cores from the electrode assembly. The length of the separator in the electrode assembly was 700 to 720 mm.

(5) Fabrication of Non-Aqueous Electrolyte Secondary Battery

The electrode assembly 14 and a lower insulating plate 9 were put into a battery case 1 made of metal (diameter: 17.8 mm, overall height: 64.8 mm) obtained by press-molding a nickel-plated steel plate (thickness: 0.20 mm). The lower insulating plate 9 was positioned so as to be sandwiched between the bottom surface of the electrode assembly 14 and the negative electrode lead terminal 6a extended downward from the electrode assembly 14. The negative electrode lead terminal 6a was resistance-welded to the inner bottom surface of the battery case 1.

An upper insulating ring was placed on the top surface of the electrode assembly 14 accommodated in the battery case 1. An inwardly protruding step portion was formed on an upper portion of the side surface of the battery case 1 at a position above the upper insulating ring, to hold the electrode assembly 14 inside the battery case 1.

A sealing plate 2 was laser-welded to the positive electrode lead terminal 5a extended upward from the battery case 1, and then a non-aqueous electrolyte was injected. The non-aqueous electrolyte had been prepared by dissolving LiPF₆ at a concentration of 1.0 M in a mixed solvent containing ethylene carbonate (EC) and ethyl methyl carbonate (EMC) in a volume ratio of 2:1, and adding thereto 0.5% by weight of cyclohexylbenzene.

Subsequently, the positive electrode lead terminal 5a was bent and accommodated in the battery case 1, and on the step portion was placed a sealing plate 2 provided with a gasket 13 on the peripheral portion thereof. The battery case 1 was sealed by crimping the opening end thereof inwardly, whereby a cylindrical lithium ion secondary battery was fabricated. This battery was of 18650 type of 18.1 mm in diameter and 65.0 mm in height and had a nominal capacity of 2600 mAh. The number of fabricated cylindrical lithium ion secondary batteries was 300.

### Example 2

A non-aqueous electrolyte secondary battery was fabricated in the same manner as in Example 1, except that a separator 7 having a three-layer structure as shown in FIG. 3 was used as the separator.

The separator 7 was prepared in the same manner as in Example 1, except that a polypropylene porous film (thickness: 8.5 μm) 7c was used in place of one of the two polyethylene porous films 7b.

In the electrode assembly 14 of the non-aqueous electrolyte secondary battery, the separator 7 was arranged such that the polypropylene porous film 7c faced the positive electrode 5.

### Example 3

A non-aqueous electrolyte secondary battery was fabricated in the same manner as in Example 1, except that a separator 7 having a three-layer structure in which the intermediate layer 7a in FIG. 2 was a polyimide-containing heat resistant porous film was used as the separator. The separator 7 was prepared in the following manner.

An NMP solution including calcium chloride and polyamic acid being a precursor of polyimide at predetermined concentrations was flow-casted, and then the resultant film was stretched. The stretched film was washed with water, and the calcium chloride was removed therefrom, to form a porous film. The resultant porous film was heated at 300° C., to be dehydrated and imidized, whereby a polyimide-containing heat resistant porous film 7a having a thickness of 3 μm was obtained. The heat resistant porous film 7a thus obtained was sandwiched between two polyethylene porous films 7b each having a thickness of 8.5 μm, and rolled by heat rolling at 80° C., to prepare a separator 7.

### Example 4

A non-aqueous electrolyte secondary battery was fabricated in the same manner as in Example 2, except that a separator 7 having a three-layer structure in which the intermediate layer 7a in FIG. 3 was a polyimide-containing heat resistant porous film was used as the separator.

The separator 7 was prepared in the same manner as in Example 3, except that a polypropylene porous film 7c was used in place of the polyethylene porous film 7b.

### Example 5

A non-aqueous electrolyte secondary battery was fabricated in the same manner as in Example 1, except that a separator 7 having a three-layer structure in which the intermediate layer 7a in FIG. 2 was polyamide-imide-containing heat resistant porous film was used as the separator.

The separator 7 was prepared by applying an NMP solution of polyamic acid on one surface of a polyethylene porous film (thickness: 8.5 μm) 7b in such a ratio that the thickness of the separator became 20 μm. The NMP solution of polyamic acid had been prepared by mixing calcium chloride, anhydrous trimellitic acid monochloride, and diamine in NMP. Before the solution was completely dried, another polyethylene porous film 7b (the same as above) was bonded to the applied surface, and dried. The resultant laminate was washed with water, and the calcium chloride was removed therefrom. Hot air of 80° C. was applied to the laminate, so that the polyamic acid was dehydrated and cyclized to be converted into polyamide-imide. The separator 7 was thus prepared.

### Example 6

A non-aqueous electrolyte secondary battery was fabricated in the same manner as in Example 2, except that a separator 7 having a three-layer structure in which the intermediate layer 7a in FIG. 3 was a polyamide-imide containing heat resistant porous film was used as the separator.

The separator 7 was prepared in the same manner as in Example 5, except that a polypropylene porous film (thickness: 8.5 μm) 7c was used in place of one of the two polyethylene porous films 7b.

### Example 7

A non-aqueous electrolyte secondary battery was fabricated in the same manner as in Example 1, except that a separator 7 having a four-layer structure as shown in FIG. 4 was used as the separator.

The separator 7 was prepared in the same manner as in Example 1, except that a polyolefin porous film 7d having a two-layer structure composed of a porous polyethylene layer (4 μm) 7e and a porous propylene layer (thickness: 4.5 μm) both formed by coextrusion was used in place of one of the two polyethylene porous films 7b.

In the electrode assembly of the non-aqueous electrolyte secondary battery, the separator 7 was arranged such that the porous polypropylene layer 7f faced the positive electrode 5.

### Example 8

A non-aqueous electrolyte secondary battery was fabricated in the same manner as in Example 1, except that a separator 7 having a five-layer structure as shown in FIG. 5 was used as the separator.

The separator 7 was prepared in the same manner as in Example 1, except that polyolefin porous films 7d and 7g each having a two-layer structure were used in place of the two polyethylene porous films 7b. Each of the polyolefin porous films 7d and 7g was a porous film composed of a porous polyethylene layer (4 μm) 7e and a porous propylene layer (thickness: 4.5 μm) both formed by coextrusion.

On the surface of the heat resistant porous film 7a on the positive electrode side, the porous polyethylene layer 7e in the polyolefin porous film 7d was disposed; and on the surface thereof on the negative electrode side, the porous polypropylene layer 7f in the polyolefin porous film 7g was disposed. In the electrode assembly of the non-aqueous electrolyte secondary battery, the separator 7 was arranged such that the porous polypropylene layer 7f faced the positive electrode 5.

### Comparative Example 1

A non-aqueous electrolyte secondary battery was fabricated in the same manner as in Example 1, except that a separator 17 having a three-layer structure as shown in FIG. 6 was used as the separator. The separator 17 was prepared in the following manner.

An aramid-containing heat resistant porous film 17a was formed in the same manner as in Example 1 on a surface of the porous polyethylene layer in a polyolefin porous film having a two-layer structure composed of a porous propylene layer (thickness: 8.5 μm) 17f and a porous polyethylene layer (thickness: 8.5 μm) 17e, and thus the separator 17 was produced.

The separator was arranged such that the heat resistant porous film 17a faced the negative electrode 6. In forming the electrode assembly 14, the winding cores were in contact with the heat resistant porous film 17a.

### Comparative Example 2

A non-aqueous electrolyte secondary battery was fabricated in the same manner as in Example 1, except that a separator 27 having a three-layer structure as shown in FIG. 7 was used as the separator.

The separator 27 was prepared by forming an aramid-containing heat resistant porous film 27a in the same manner as in Example 1 on both surfaces of a polyethylene porous film (thickness: 14 μm) 27b.

### Comparative Example 3

A non-aqueous electrolyte secondary battery was fabricated in the same manner as in Example 1, except that a separator 37 having a two-layer structure as shown in FIG. 8 was used as the separator.

The separator 37 was prepared by forming an aramid-containing heat resistant porous film 37a in the same manner as in Example 1 on one surface of a polyethylene porous film (thickness: 17 μm) 37b.

The separator 37 was arranged such that the heat resistant porous film 37a faced the positive electrode 5. In forming the electrode assembly 14, the winding cores were in contact with the heat resistant porous film 37a.

The non-aqueous electrolyte secondary batteries of Examples and Comparative Examples were evaluated for the defective rate based on a leakage inspection.

The leakage inspection was performed by applying a high voltage (250 V), before injecting the non-aqueous electrolyte in the process of secondary battery fabrication, across the positive electrode lead terminal and the battery case being an external negative electrode terminal, to measure the current waveform for detecting “good” and “defective” in products. Specifically, it was judged as “defective” only when the current waveform measured in the inspection fell outside a predetermined rage of good products.

The evaluation results are shown in Table 1 along with the layer structure of the separator. In all of the separators used in Examples and Comparative Examples, the thickness of the separator was 20 μm, and the thickness of the heat resistant porous film was 3 μm.

The defective rate in the leakage inspection was expressed by the number of defectives per 300 secondary batteries and the percentage thereof. In Table 1, the polyethylene porous film and the polypropylene porous film are denoted by “PE” and “PP”, respectively. The polyimide and polyamide-imide are denoted by “PI” and “PAI”, respectively.

TABLE 1

| | Layer structure of | Reference | Defective rate in |
|---|---|---|---|
| | separator | drawing | leakage inspection |
| Ex. 1 | PE/aramid/PE | FIG. 2 | 0% (0 defectives) |
| Ex. 2 | PE/aramid/PP | FIG. 3 | 0% (0 defectives) |
| Ex. 3 | PE/PI/PE | FIG. 2 | 0% (0 defectives) |
| Ex. 4 | PE/PI/PP | FIG. 3 | 0% (0 defectives) |
| Ex. 5 | PE/PAI/PE | FIG. 2 | 0% (0 defectives) |
| Ex. 6 | PE/PAI/PP | FIG. 3 | 0% (0 defectives) |
| Ex. 7 | PE/aramid/PE/PP | FIG. 4 | 0% (0 defectives) |
| Ex. 8 | PE/PP/aramid/PE/ | FIG. 5 | 0% (0 defectives) |
| | PP | | |
| Com. Ex. 1 | aramid/PE/PP | FIG. 6 | 1% (3 defectives) |
| Com. Ex. 2 | aramid/PE/aramid | FIG. 7 | 0.67% (2 defectives) |
| Com. Ex. 3 | PE/aramid | FIG. 8 | 2.3% (7 defectives) |

As shown in FIG. 1, in the non-aqueous electrolyte secondary batteries of Examples 1 to 8, using the separators 7 having a three- to five-layer structure, no defective was detected in the leakage inspection in the process of battery fabrication. In contrast, three defectives were detected out of 300 secondary batteries of Comparative Example 1, two defectives were detected out of 300 secondary batteries of Comparative Example 2, and seven defectives were detected out of 300 secondary batteries of Comparative Example 3.

In Examples 1 to 8, the first and second polyolefin porous films were disposed on the surfaces of the heat resistant porous film, so that a well-balanced layer configuration was achieved. Therefore, after the electrode assembly 14 had been formed by clamping the separator with winding cores and winding, the winding cores were removed smoothly. Even after the winding cores had been removed, the separator portion 16 at the winding start portion remained undamaged and undisplaced in the winding core removal direction. Presumably because of this, the defective rate in the leakage inspection in the process of battery fabrication was reduced.

With regard to the secondary batteries of Comparative Examples 1 to 3, the winding cores were in direct contact with the heat resistant porous film with heat resistance, and therefore, the winding cores were not smoothly removed. The defective rate was high in Comparative Example 3, which was presumably attributed to, in addition to the above-described reason, a bad balance between the front and back layers due to the two-layer structure.

The defectives in the secondary batteries of Comparative Examples 1 to 3 detected in the leakage inspection were disassembled, and the appearance of the separator portions 16 at the winding start portion was visually inspected. As a result, the separator portions 16 had been displaced in the winding core removal direction, and leakage of current had occurred at these portions. With respect to the secondary batteries of Comparative Examples which were judged as “good”, the appearance of the separator portions 16 was visually inspected in the same manner as above. As a result, a similar tendency to that observed in the defectives detected in the leakage inspection was observed. Specifically, the separator portions 16 at the winding start portion had been displaced in the winding core removal direction, although the displacement had not been so severe as to result in damage. Particularly in Comparative Example 3, the degree of displacement was large.

Further, with respect to the secondary batteries of Examples 1 to 8 also, the “good” batteries in the leakage inspection were disassembled, and the appearance of the separator portions 16 at the winding start portion was visually inspected. As a result, no displacement was observed in these separator portions 16. In addition, no winding displacement of the component elements in the electrode assembly was observed.

The foregoing results of the leakage inspection on the secondary batteries of Examples 1 to 8 show that, by disposing the first and second polyolefin porous films on the surfaces of the heat resistant porous film, it is possible to effectively suppress the displacement of or damage to the separator which may occur as the winding cores are being removed.

Although a cylindrical lithium ion secondary battery was used in Examples of the present invention, similar effects can be obtained by using a cylindrical lithium primary battery, a cylindrical alkaline storage battery, and a prismatic lithium ion secondary battery. The configuration according to the present invention can be applied, with similar effects, to any type of batteries including a spirally-wound electrode assembly.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The battery according to the present invention is particularly useful for a lithium ion secondary battery including a wound electrode assembly, whose energy density has been improved by, for example, using a positive and a negative electrode with higher density.

### REFERENCE SIGNS LIST

1 Battery case
2 Sealing plate
5 Positive electrode
5a Positive electrode lead terminal
6 Negative electrode
6a Negative electrode lead terminal
7 Separator
7a Heat resistant porous film
7b Polyethylene porous film
7c Polypropylene porous film
7d First polyolefin porous film
7e Porous polyethylene layer
7f Porous polypropylene layer
7g Second polyolefin porous film
8 Upper insulating ring
9 Lower insulating plate
12 Positive electrode external terminal
13 Gasket
14 Electrode assembly
17 Separator
17a Heat resistant porous film
17e Porous polyethylene layer
17f Porous polypropylene layer
27 Separator
27a Heat resistant porous film
27b Polyethylene porous film
37 Separator
37a Heat resistant porous film
37b Polyethylene porous film

1. A non-aqueous electrolyte secondary battery comprising:
an electrode assembly which includes a positive electrode including a belt-like positive electrode current collector and a positive electrode active material layer adhering to a surface of the positive electrode current collector, a negative electrode including a belt-like negative electrode current collector and a negative electrode active material layer adhering to a surface of the negative electrode current collector, and a separator for insulating the positive electrode from the negative electrode, the positive electrode, the negative electrode, and the separator being spirally wound together; and
a non-aqueous electrolyte, wherein
the separator includes a heat resistant porous film including a heat resistant resin, a first polyolefin porous film covering entirely a surface of the heat resistant porous film on the positive electrode side, and a second polyolefin porous film covering entirely a surface of the heat resistant porous film on the negative electrode side;
the heat resistant resin has a melting point or a heat deflection temperature higher than those of polyolefins included in the first polyolefin porous film and the second polyolefin porous film; and
the heat resistant porous film has a thickness of 1 to 16 μm, the first polyolefin porous film has a thickness of 2 to 17 μm, the second polyolefin porous film has a thickness of 2 to 17 μm, and the separator has a thickness of 5 to 35 μm.

2. The non-aqueous electrolyte secondary battery in accordance with claim 1, wherein the electrode assembly includes no winding core.

3. The non-aqueous electrolyte secondary battery in accordance with claim 1, wherein each of the first polyolefin porous film and the second polyolefin porous film has a surface having a coefficient of static friction of 0.09 to 0.17.

4. The non-aqueous electrolyte secondary battery in accordance with claim 1, wherein the heat resistant resin has a heat deflection temperature of 260° C. or higher.

5. The non-aqueous electrolyte secondary battery in accordance with claim 1, wherein the heat resistant resin is at least one selected from an aramid, a polyimide, and a polyamide-imide.

6. The non-aqueous electrolyte secondary battery in accordance with claim 1, wherein the heat resistant porous film further includes an inorganic filler.

7. The non-aqueous electrolyte secondary battery in accordance with claim 1, wherein the first polyolefin porous film comprises a single porous polypropylene layer.

8. The non-aqueous electrolyte secondary battery in accordance with claim 1, wherein the second polyolefin porous film comprises a single porous polyethylene layer.

9. The non-aqueous electrolyte secondary battery in accordance with claim 1, wherein the first polyolefin porous film comprises two or more porous polyolefin layers, and an outermost surface layer thereof is a porous polypropylene layer.

10. The non-aqueous electrolyte secondary battery in accordance with claim 1, wherein the second polyolefin porous film comprises two or more porous polyolefin layers, and an outermost surface layer thereof is a porous polyethylene layer.

11. A method for producing a non-aqueous electrolyte secondary battery, comprising the steps of:
preparing a separator which includes a heat resistant porous film including a heat resistant resin, a first polyolefin porous film covering entirely one surface of the heat resistant porous film, and a second polyolefin porous film covering entirely the other surface of the heat resistant porous film, wherein the heat resistant resin has a melting point or a heat deflection temperature higher than those of polyolefins included in the first polyolefin porous film and the second polyolefin porous film, and the heat resistant porous film has a thickness of 1 to 16 μm, the first polyolefin porous film has a thickness of 2 to 17 μm, the second polyolefin porous film has a thickness of 2 to 17 μm, and the separator has an overall thickness of 5 to 35 μm;
preparing a positive electrode including a belt-like positive electrode current collector and a positive electrode active material layer adhering to a surface of the positive electrode current collector, and a negative electrode including a belt-like negative electrode current collector and a negative electrode active material layer adhering to a surface of the negative electrode current collector;
clamping one end of the separator in a longitudinal direction thereof with a pair of winding cores, and winding spirally the positive electrode, the negative electrode, and the separator disposed so as to insulate the positive electrode from the negative electrode, with the first polyolefin porous film being arranged to face the positive electrode and the second polyolefin porous film being arranged to face the negative electrode, to form an electrode assembly;
removing the winding cores from the electrode assembly; and
putting the electrode assembly and a non-aqueous electrolyte into a battery case.
